(19) United States
(12) Patent Application Publication
(10) Pub. No.: US 2010/0223736 A1
(43) Pub. Date: Sep. 9, 2010

(54) METHOD FOR TANNING HIDES AND/OR FURS

(75) Inventor: Olga Jadrova, Samara (RU)

Correspondence Address: HAMRE, SCHUMANN, MUELLER & LARSON, P.C., P.O. BOX 2902, MINNEAPOLIS, MN, 55402-0902, US

(73) Assignee: PROGETTO IDEA SRL, Roma (IT)

(21) Appl. No.: 12/784,982

(22) Filed: May 21, 2010

Related U.S. Application Data
(63) Continuation of application No. PCT/EP2007/062687, filed on Nov. 22, 2007.

(51) Int. Cl. C14C 3/18

(52) U.S. Cl. 8/94.33

(57) ABSTRACT

A method for tanning hides and/or furs comprises at least a first step in which a tanning compound is used, in order to tan said hides and/or furs, to which a saline compound is added.

### FIELD OF THE INVENTION

The present invention concerns a method for tanning hides and/or furs. Hereafter, by “hide” we shall mean hides themselves and also fur.

In particular the method can be used in the hide industry for tanning semi-worked hide products.

### BACKGROUND OF THE INVENTION

Methods are known for tanning semi-worked hide and/or fur products, which use the derivates of chemical compounds with methylol groups, for example cyanogen-diamide resins, and which do not use chrome compounds.

In particular, a method is known, from the patent RU-B-2182178, for tanning semi-worked hide products which uses derivates of the bactericide preparation polyhexamethyleneguanidine (PHMG). In this method the tanning effect, and the loading of the dermis and the part of hide, is obtained by using the above tanning compound with methylol groups. The tanning compound also has a fungicide effect on the semi-worked product. One disadvantage of this known method is that it is polluting, since the tanning compound that is used releases a high quantity of formaldehyde into the finished product, into the waste waters and in general into the environment surrounding the area where the hides are worked.

From the patent application GB-A-2,371,559 it is known a tanning process and agents for the production of tanned and optionally retanned leather by treatment of an optionally (pre)tanned animal hide or pelt with an aldehyde-based treatment agent (A), wherein such hide or pelt is treated with (A) an aldehyde-based treatment agent which may be (F) a tanning aldehyde or an aldehyde-based stability and/or fastness improving agent or (S) an aldehyde-based syntan, and with (H) at least one hydrazine compound which is semicarbazide or aminoguanidine or a salt thereof, in any desired sequence, or is treated with a reaction product (A_{H}) of (A) with (H), treatment agents for the production of leather, which are mixtures of (A) with (H) or reaction products (A_{H}) in particular reaction products (E_{S}) of (S) with (H), their production and their use.

Purpose of the present invention is to perfect a method for tanning hides which increases the protection of the environment where the production of the hides occurs, which reduces the quantity of formaldehyde both in the finished product and in the waste waters, and also in the environment surrounding the area where the hides are worked.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a method for tanning hides according to the present invention comprises at least a first step in which a tanning compound is used to tan the hides.

According to a characteristic feature of the present invention, in said first step a saline compound, for example sodium sulfite or sodium bisulfite, is added to the tanning compound.

Said first step also comprises a first substep in which the tanning compound is made through the synthesis of a bactericide preparation, a solution of formaldehyde and at least one catalyst.

Advantageously, the bactericide preparation comprises PHMG, while the catalyst comprises acetic acid, or a solution of sodium tetraborate.

The saline compound added to the tanning compound is able to react with the free formaldehyde present in the chemical structure of the tanning compound. This reaction determines a reduction in the quantity of free formaldehyde and the consequent reduction in toxicity of the compound used in the method for working hides. Furthermore, following this reaction, the formaldehyde in its gaseous state is not emitted into the environment surrounding the area where the hides are worked. Therefore, the quantity of formaldehyde present in the waste waters, the air and the tanned hides is limited and consequently does not exceed the values permitted by the legislation in force.

### DETAILED DESCRIPTION OF A PREFERENTIAL FORM OF EMBODIMENT

These and other characteristics of the present invention will become apparent from the following description of a preferential form of embodiment, given as a non-restrictive example.

A method for tanning a semi-worked hide according to the present invention uses a tanning compound, in this case a resin, obtained through the synthesis of a bactericide preparation such as PHMG, with a solution of formaldehyde (CH₂O).

In this synthesis the ratio between the amounts of PHMG and of CH₂O is respectively comprised between about 1:2 and about 1:4.

The catalyst used in the synthesis can comprise either a solution of 0.01 h of sodium tetraborate (Na₂B₄O₇) or acetic acid.

Moreover, the synthesis for obtaining the tanning compound has a duration comprised between about 2 hours and about 8 hours and occurs at a temperature comprised between about 45° C. and about 100° C.

From laboratory analyses carried out, it is clear that the resin that makes up the tanning compound comprises about 11% of CH₂O, values comprised between about 20% and about 26% of methylol groups, and values comprised between about 30% and about 40% of dry residue.

In order to carry out said analyses of the tanning compound, first of all the pH of the resin was checked, which during the period the resin is preserved normally decreases to values of lower than 3; the resin was also neutralized with Na₂SO₃ or NaOH in order to return the pH of the resin to a value of 7.

Subsequently, the percentage of CH₂O in the tanning compound was determined, using the Kricevskij method and the Golovteeva method, and also the percentage of methylol groups using the sulfite iodometric method.

In applying the Kricevskij method 50 ml of a solution of sodium sulfite (Na₂SO₃) and two or three drops of an indicator, advantageously thymolphthalein, were poured into a conical flask.

The solution of Na₂SO₃ was neutralized by means of chloric acid (HCl) or sulphuric acid (H₂SO₄) until the blue color of the indicator disappeared.

Subsequently 2 gr of resin were added to the flask which they titrated with the acid until the color of the indicator was recovered.

Alternately, it was possible to proceed without using the indicator. In this case the solution of Na₂SO₃ and resin was neutralized by titrating with one of the above acids until a pH value of the solution equal to 9.6 was reached.

The formula used to determine the percentage of free formaldehyde X is as follows:

$$X = \frac{V \times M \times 0.003}{H}$$

where V is the volume of acid for titration, expressed in milliliters, M is the molarity of the acid and H is the mass of the sample expressed in grams.

In the Golovteeva method reference was made to the following formula:

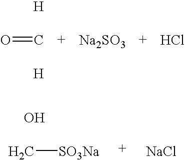

Using a solution of NaOH 0.1 n, the excess acid was titrated. Subsequently, a quantity of resin suspension comprised between about 2 g and about 2.5 g was introduced into a flask having a volume equal to 250 ml, in which a quantity of water was also introduced, comprised between about 100 ml and about 150 ml. The whole was mixed and poured, after being filtered, into a volumetric flask with a volume of 250 ml. Then 25 ml of the solution thus formed were taken and poured into a conical flask also having a volume of 250 ml. Then 20 ml of HCl solution (0.1 n) were added, 50 ml of Na₂SO₃ solution (concentration 25%) and five drops of thymolphthalein. The solution thus formed was mixed and titrated until the blue color of the indicator was obtained.

The concentration of free formaldehyde X₁ in percentage was taken from the following formula:

$${X}_{1} = \frac{0.003 ( a 1 - a 2 ) \times K \times 250}{g \times 25}$$

where 0.003 is the quantity of CH₂O, corresponding to 1 ml of the solution of NaOH 0.1 n, expressed in grams, a1 is the volume of NaOH expressed in milliliters, a2 is the volume of NaOH during titration of the resin suspension, expressed in milliliters, K is the correction of 0.1 n of the NaOH solution and g is the quantity of resin suspension, expressed in grams.

On the contrary, in order to determine the methylol groups, the sulfite iodometric method was used.

In this case 0.4 g of resin, distilled water and 10 ml of NaOH solution in a concentration of 20% were introduced into a volumetric flask with a volume of 250 ml. Subsequently, 10 ml of this solution, 20 ml of a solution of iodine 0.1 n and 10 ml of a solution of NaOH 1 n were poured into a conical flask and left to rest for about 10 minutes. Afterwards, 15 ml of a solution of H₂SO₃ 1 h were added to the solution present in the conical flask. The iodine emanated was then titrated with a solution of sodium thiosulfate 0.1 h inside starch, until decoloring occurred.

The total concentration of the methylol groups and formaldehyde X₂, expressed as a percentage, was found from the following formula:

$${X}_{2} = \frac{0.0015 ( a 1 - a 2 ) \times K 250}{10 g}$$

where a1 is the volume of the solution of sodium thiosulfate (0.1 n) during titration, expressed in milliliters, a2 is the volume of sodium thiosulfate during titration of the solution, expressed in milliliters, K is the correction of the titer of the sodium thiosulfate solution and g is the quantity of resin suspension, expressed in grams.

The concentration X₃ of the methylol groups, expressed as a percentage, is given by the following formula:

$${X}_{3} = \frac{31 ( x - a )}{30}$$

where x is the total concentration of the methylol groups and formaldehyde, expressed as a percentage, a is the concentration of formaldehyde, expressed as a percentage while 30 and 31 represent respectively the molecular weight of the groups of methylol and of formaldehyde.

The method for tanning hides and/or furs which uses the tanning compound obtained by means of said synthesis, in a concentration comprised between about 5 gr/l and about 25 gr/l, has a duration comprised between about 3 hours and about 6 hours, and occurs at a temperature comprised between about 18° C. and about 37° C.

In the method for tanning hides and/or furs according to the present invention, sodium sulfite (Na₂SO₃) or sodium bisulfite (NaHSO₃) is also added to the tanning compound. The volume of these saline solutions to be used depends on the concentration of free formaldehyde present in the tanning compound, deducible from the formulas given above. The saline solutions therefore react with the free formaldehyde present in the chemical structure of the tanning compound, absorbing it.

The presence of the saline solutions also determines an increase in the pH of the tanning compound. In this way, when the pH of the tanning is higher the tanning effect of the tanning solution increases and on the contrary its presence in the worked solution decreases.

The consumption of sodium sulfite or sodium bisulfite is normally comprised between about 1% and about 4% of the mass of the semi-worked product to be tanned.

For example, let us consider the tanning of a semi-worked fur product using the tanning compound according to the present invention, in a concentration comprised between about 5 gr/l and 15 gr/l at a temperature comprised between about 18° C. and about 30° C. After an hour's tanning, a quantity of sodium bisulfite comprised between about 0.8% and about 2% of the mass of the semi-worked product is added to the tanning compound. The overall duration of the treatment is comprised between about 3 hours and about 5 hours.

As a further example let us consider the tanning of a semi-worked hide product using the tanning compound according to the present invention, in a concentration comprised between about 10 gr/l and about 25 gr/l at a temperature comprised between about 25° C. and about 35° C. After three hours of tanning, a quantity of sodium sulfite comprised between about 1.5% and about 2.5% of the mass of the semi-worked product is added to the tanning compound. The overall duration of the treatment in this case too is comprised between about 3 hours and about 5 hours.

It is clear that modifications and/or additions of steps may be made to the method for tanning hides and/or furs as described heretofore, without departing from the field and scope of the present invention.

It is also clear that, although the present invention has been described with reference to some specific examples, a person of skill in the art shall certainly be able to achieve many other equivalent forms of method for tanning hides and/or furs, having the characteristics as set forth in the claims and hence all coming within the field of protection defined thereby.

1. A method for tanning hides and/or furs, comprising at least a first step in which a tanning compound is used, in order to tan said hides and/or furs, to which a saline compound is added, wherein said first step comprises at least a first substep in which said tanning compound is made through the synthesis of a bactericide preparation comprising polyhexamethyleneguanidine (PHMG), a solution of formaldehyde and at least one catalyst.

2. The method as in claim 1, wherein said saline compound comprises sodium sulfite.

3. The method as in claim 1, wherein said saline compound comprises sodium bisulfite.

4. The method as in claim 1, wherein said catalyst comprises a solution of sodium tetraborate.

5. The method as in claim 1, wherein said catalyst comprises acetic acid.

6. The method as in claim 1, wherein said first substep is performed at a temperature comprised between about 45° C. and about 100° C.

7. The method as in claim 1, wherein said first substep has a duration comprised between about 2 hours and about 8 hours.

8. The method as in claim 1, wherein said first step has a duration comprised between about 3 hours and about 6 hours.

9. The method as in claim 1, wherein said first step is performed at a temperature comprised between about 18° C. and about 37° C.
